(19) United States
(12) Patent Application Publication
(10) Pub. No.: US 2025/0046154 A1
(43) Pub. Date: Feb. 6, 2025

(54) LOCATION-BASED CONNECTION BETWEEN CONSUMER VIDEO GAMES AND FORMAL GAME OF CHANCE TECHNOLOGIES

(71) Applicant: IGT, Las Vegas, NV (US)

(72) Inventors: Stefan Keilwert, St. Josef (AT); Michael Russ, Graz (AT); David Froy, Lakeville-Westmorland (CA); David Small, Moncton (CA); Soheil Latifi, Brampton (CA)

(21) Appl. No.: 18/228,874

(22) Filed: Aug. 1, 2023

(51) Int. Cl. G07F 17/32; A63F 13/798

(52) U.S. Cl. CPC G07F 17/3288; A63F 13/798; G07F 17/3255

(57) ABSTRACT

Embodiments of the present disclosure are directed to providing a game of chance within a skills-based video game based on a location of a player of the skills-based video game. While game of chance features are prohibited in skills-based games in many jurisdictions, there is an opportunity for wagering game publishers, who hold licenses for such games as well as the entire server infrastructure of decentralized certified random number generators, associated with decades of experience with designing such games. The opportunity would be in the form of partnerships between video game publishers and wagering game publishers to bring back loot box-like, in-game wagering mechanisms. Generally speaking, this can be accomplished using the systems and services of the video game publishers to support skills-based aspects of the games while using the systems and services of the wagering game publishers to support the game of chance aspects of the game.

### BACKGROUND

The present disclosure is generally directed to conducting an electronic game and, in particular, toward providing a game of chance within a skills-based video game based on a location of a player of the skills-based video game.

Video game publishers tried to implement loot box elements, paid with real money, into skill-based games. However, those have been abandoned from video games due to certain legal requirements which required the publishers to entirely remove such game of chance-like elements or find mitigated ways around them, e.g., such as wagering free in-game currency only. Additionally, the requirements for implementing games of chance elements within a skills-based game vary by jurisdiction or geographic location of the player. Hence, there is a need in the art for methods and systems of implementing games of chance or game of chance-like features within video or other skills-based games based on a location of a player of the skills-based video game.

### BRIEF SUMMARY

In certain embodiments, the present disclosure relates to providing a game of chance within a skills-based video game based on a location of a player of the skills-based video game.

According to one embodiment, a method for operating an electronic game can comprise executing, on a gaming system, a skills-based electronic game which can include a game of chance element. A geographic location at which the gaming system is currently located can be determined and a host system of a plurality of host systems of a distributed random number generator infrastructure can be identified based on the determined geographic location.

A session of the game of chance can be conducted within the skills-based game. A random number can be received from the identified host system of the plurality of host systems of the distributed random number generator infrastructure and a result of the session of the game of chance can be determined based on the received random number. In some cases, receiving the random number from the identified host system of the plurality of host systems of the distributed random number generator infrastructure and determining the result of the session of the game of chance based on the received random number can be performed in real time while conducting the session of the game of chance within the skills-based game. An indication of the determined result of the session of the game of chance can then be provided.

In some cases, the gaming system can provide, to a gaming host, a set of credentials for a player of the skills-based game along with the determined geographic location and receive, from the gaming host, an indication of age verification for the player of the skills-based game. In such cases, conducting the session of the game of chance within the skills-based game can comprise conducting a wagering session of the game of chance in response to the received indication of age verification for the player of the skills-based game indicates the player is verified for wagering based on the determined geographic location. For example, the result of the wagering session of the game of chance can comprise a voucher to a gaming venue selected from a plurality of gaming venues based on the determined geographic location. Additionally, or alternatively, conducting the session of the game of chance within the skills-based game can comprise conducting a non-wagering session of the game of chance in response to the received indication of age verification for the player of the skills-based game indicates the player is not verified for wagering based on the determined geographic location. The result of the non-wagering session of the game of chance can, for example, affect the skills-based game.

According to another embodiment, a gaming system can comprise a processor and a memory coupled with and readable by the processor. The memory can have stored therein a set of instructions which, when executed by the processor, causes the processor to execute a skills-based electronic game which can include a game of chance element. The instructions can further cause the processor to determine a geographic location at which the gaming system is currently located, identify a host system of a plurality of host systems of a distributed random number generator infrastructure based on the determined geographic location, conduct a session of the game of chance within the skills-based game, receive a random number from the identified host system of the plurality of host systems of the distributed random number generator infrastructure, determine a result of the session of the game of chance based on the received random number, and provide, within the skills-based game, an indication of the determined result of the session of the game of chance.

The identified host system of the plurality of host systems of the distributed random number generator infrastructure can comprise, for example, a host system of a gaming venue. Additionally, or alternatively, the game of chance can comprise a wide-area progressive. In some cases, the instructions can further cause the processor to receive, from the host system of the gaming venue, odds for winning the game of chance and present, to a player of the skills-based game, through a display device of the gaming system, the received odds for winning the game of chance. Additionally, or alternatively, the instructions can further cause the processor to receive, from the host system of the gaming venue, a paytable for the game of chance and present, to a player of the skills-based game, through a display device of the gaming system, the received paytable for the game of chance. For example, the paytable for the game of chance can be non-linear and can be based on an amount of a wager made on the game of chance by the player of the skills-based game. The instructions can additionally, or alternatively, cause the processor to receive, from a gaming host, a set of player preferences for a player of the skills-based game. In such cases, conducting the session of the game of chance within the skills-based game can be based on the received player preferences.

According to yet another embodiment, a non-transitory, computer-readable medium can comprise a set of instructions stored therein which, when executed by a processor, causes the processor to execute a skills-based electronic game which includes a game of chance element, determine a geographic location at which the gaming system is currently located, identify a host system of a plurality of host systems of a distributed random number generator infrastructure based on the determined geographic location, conduct a session of the game of chance within the skills-based game, receive a random number from the identified host system of the plurality of host systems of the distributed random number generator infrastructure, determine a result of the session of the game of chance based on the received random number, and provide, within the skills-based game, an indication of the determined result of the session of the game of chance.

In some cases, the instructions can further cause the processor to receive, from a gaming host, a set of preferences for the game of chance and conducting the session of the game of chance within the skills-based game can be based on the received preferences. For example, the set of preferences can define responsible gaming limits for conducting the session of the game of chance. The responsible gaming limits can be pre-defined by a player of the skills-based game or by the gaming host, for example. In some cases, the set of preferences can indicate an account lock on an account of a player of the skills-based game.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure may be implemented.

FIG. 2 is a block diagram illustrating additional details of components of an exemplary gaming system according to one embodiment of the present disclosure.

FIG. 3 is a block diagram illustrating additional details of components of an exemplary gaming host according to one embodiment of the present disclosure.

FIG. 4 is a block diagram illustrating additional details of components of an exemplary gambling host according to one embodiment of the present disclosure.

FIG. 5 is a flowchart illustrating an exemplary process for operating an electronic game according to one embodiment of the present disclosure.

FIG. 6 is a flowchart illustrating an exemplary process for operating an electronic game according to another embodiment of the present disclosure.

FIG. 7 is a flowchart illustrating an exemplary process for operating an electronic game according to yet another embodiment of the present disclosure.

### DETAILED DESCRIPTION

Embodiments of the present disclosure are directed to providing a game of chance within a skills-based video game based on a location of a player of the skills-based video game. While game of chance features are prohibited in skills-based games in many jurisdictions, there is an opportunity for wagering game publishers, who hold licenses for such games as well as the entire server infrastructure of decentralized certified random number generators, associated with decades of experience with designing such games. The opportunity would be in the form of partnerships between video game publishers and wagering game publishers to bring back loot box-like, in-game wagering mechanisms. Generally speaking, and as will be described in greater detail below, this can be accomplished using the systems and services of the video game publishers to support skills-based aspects of the games while using the systems and services of the wagering game publishers to support the game of chance aspects of the game.

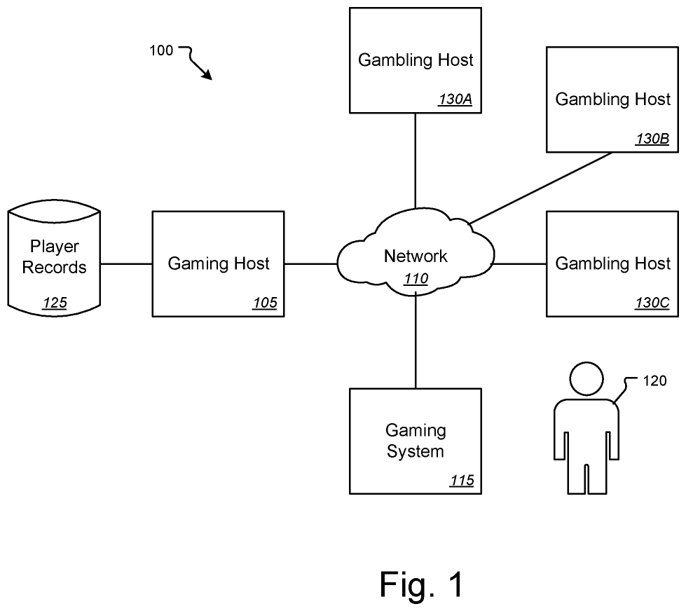

FIG. 1 is a block diagram illustrating an exemplary environment in which embodiments of the present disclosure may be implemented. As illustrated in this example, the environment 100 can comprise a gaming host 105 communicatively coupled with a communications network 110. The gaming host 105 can comprise any one or more servers and/or other computing devices. The communications network 110 can comprise any one or more wired and/or wireless, local-area and/or wide-area networks including but not limited to the Internet. Also coupled with the communications network 110 can be a gaming system 115. The gaming system 115 can comprise, for example, a game console, personal computer, or other computing device executing a video game or other skills-based game. Generally speaking, and as known in the art, the gaming host 105 can monitor and manage execution of the skills-based game on the gaming system 115 and provide services related to play of the skills-based game such as remote play between any number of players. The gaming system 105 can maintain a set of player records 125 for players registered with and known to the gaming host 105. These records 125 can include, but are not limited to, player identity information, payment information, etc.

The environment 100 can further comprise a plurality of gambling hosts 130A-130C. Each gambling host 130A-130C can comprise any number of servers and/or other computing devices as may be used, for example, to support operation of a casino or other gaming venue. Among other things, the plurality of gambling hosts 130A-130C can provide or be part of a distributed, certified random number generator infrastructure as known in the art and used to support, for example, video lottery terminals and other games of chance that utilize random numbers. According to one embodiment, the gambling hosts 130A-130C can be distributed across a number of different geographic regions, e.g., cities, states, provinces, prefectures, countries, continents, etc. Each gambling host 130A-130C can be certified for use to support games of chance by appropriated governing bodies in the geographic region in which it is located. As will be described in greater detail, this certification can be leveraged to support games of chance within skills-based games.

According to one embodiment, the gambling system 130 can support execution of a game of chance within a skills-based game executed on the gaming system 115. Generally speaking, and as will be described further below, while a skills-based electronic game is executing on the gaming system 115, a game of chance can be presented on the gaming system 115. The session of the game of chance can be conducted on the gaming system 115 within the skills-based game. A result of the game of chance can be determined based on a random number generated or provided by a gambling host 130A. selected based on a location of the gaming system 115 executing the skills-based game. For example, the gaming system 115 and/or gaming host 105 can determine the geographic location of the gamine system 115 based on any of a number of known methods and select a gambling host 130A within a same region or area such as a gambling host 130A supporting a casino or other gaming venue within a same city, state, province, prefecture, country, etc. as the gaming system 115.

According to one embodiment, the gaming system 115 and/or gaming host 105 can connect to the selected gambling host 130A through an Application Program Interface (API). Such an interface can support wired or wireless data exchange via the Internet or other protocols. For example, the gaming system 115 executing the skills-based came can request a random number from the selected gambling host 130A of the certified random number generator infrastructure via a command through the API, and receive it via the interface for use in the game of chance where it can be used to determine the results of the game of chance. In some cases, communication via such an API can be secured and encrypted through technologies like Secure Sockets Layer (SSL), Transport Layer Security (TLS), etc. The random number can be generated in real time by the selected gambling host 130A of the certified random number generator infrastructure in real-time, or, as a series of results in response to requests by the gaming system 115. The skill-based game could then use one transmitted random number or draw from the pool of sent random numbers. Alternatively, the outcome of an in-game event can be predetermined, e.g., requested by the gaming system 115 previously, so that in the moment of presenting the outcome to the player the results are available, just not shown to the player, e.g., similar to scratch tickets. According to various embodiments, the certified random number generator infrastructure can be configured to draw a number from a given range, e.g. 0-10, can be configured to draw a binary outcome, e.g., true/false, can be configured to draw a series of random numbers and return it to the requester, can be configured to create a pool of random numbers and draw from the pool, i.e., with or without putting back drawn numbers, can be reset, can be configure to draw numbers continuously, at the moment a request is received the current number is returned, can be controlled and configured via an API remotely by the skills-based game server, and others.

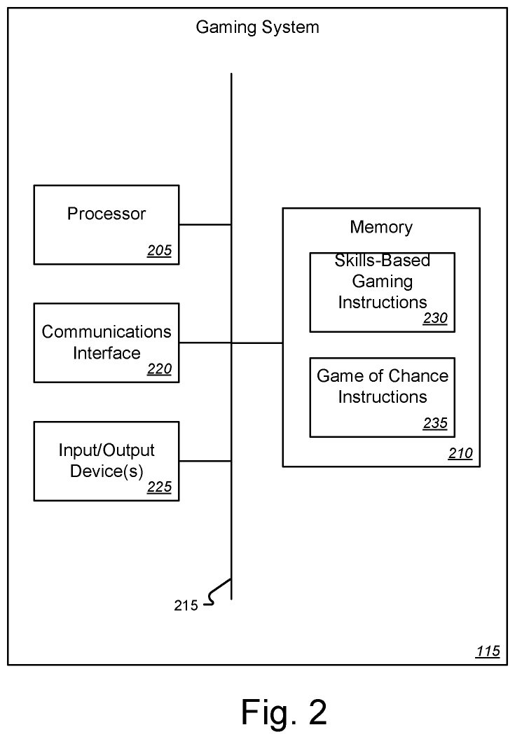

FIG. 2 is a block diagram illustrating additional details of components of an exemplary gaming system according to one embodiment of the present disclosure. As illustrated in this example, a gaming system 115 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming system 115 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interfaces 220 and one or more input/output devices 225 via the communications bus 215. The communication interfaces 215 can comprise, for example, a Bluetooth, WiFi, cellular, and/or other type of wireless communications interface. The input/output devices can include, but are not limited to a display device such as a Liquid Crystal Display (LCD), Light Emitting Diode (LED), Organic Light Emitting Diode (OLED), or other type of display.

The memory 210 can store therein a set of gaming instructions 230 which, when executed by the processor 205, cause the processor 205 to execute a skills-based electronic game which can include a game of chance element. The memory 210 can also store therein a set of game of chance instructions 235 which, when executed by the processor 205, causes the processor 205 to determine a geographic location at which the gaming system 115 is currently located and identify a host system 130A of a plurality of host systems 130A-130C of a distributed random number generator infrastructure based on the determined geographic location. The identified host system of the plurality of host systems of the distributed random number generator infrastructure can comprise, for example, a host system of a gaming venue within the same geographic area as determined location of the player.

In some cases, the game of chance instructions 235 can also cause the processor 205 to provide, to a gaming host 105, through the communications interface 220, a set of credentials for a player 120 of the skills-based game along with the determined geographic location and receive, from the gaming host 105, through the communications interface 220, an indication of age verification for the player of the skills-based game.

The game of chance instructions 235 can further cause the processor 205 to request and receive player preferences and/or game of chance information from the gaming host 105 and/or gambling host 130 through the communications interface 220. For example, the game of chance can comprise a wide-area progressive for the determined region or area of the gaming system 115. The preferences can define, for example, a type of game of chance the player prefers, e.g., slots, video poker, etc. In some cases, odds for winning the game of chance, a paytable for the game of chance, a set of player preferences for a player of the skills-based game, and or other information can be received. The game of chance instructions 235 can further cause the processor 205 to apply the player preferences and/or present the player preferences and/or game of chance information to a player of the skills-based game through a display device or other input/output device 225 of the gaming system 115. For example, the paytable for the game of chance can be non-linear and can be based on an amount of a wager made on the game of chance by the player of the skills-based game.

The game of chance instructions 235 can further cause the processor 205 to conduct a session of the game of chance can be conducted 545 within the skills-based game. Conducting the session of the game of chance within the skills-based game can comprise conducting a wagering session of the game of chance in response to the received indication of age verification for the player of the skills-based game indicates the player is verified for wagering based on the determined geographic location. For example, the result of the wagering session of the game of chance can comprise a voucher to a gaming venue selected from a plurality of gaming venues based on the determined geographic location. Such a voucher may be for one type of game within the gaming venue. For example, the voucher may be for a one type of game that is thematically related to the skills-based game. Additionally, or alternatively, a voucher won within the skills-based game can comprise a voucher redeemable within a skills-based game executed on a gaming system physically located within an eligible geographic area.

Additionally, or alternatively, conducting the session of the game of chance within the skills-based game can comprise conducting a non-wagering session of the game of chance in response to the received indication of age verification for the player of the skills-based game indicates the player is not verified for wagering based on the determined geographic location. The result of the non-wagering session of the game of chance can, for example, affect the skills-based game. Additionally, or alternatively, conducting the session of the game of chance within the skills-based game can be based on the received preferences. For example, the set of preferences can define responsible gaming limits for conducting the session of the game of chance. The responsible gaming limits can be pre-defined by a player of the skills-based game or by the gaming host, for example. In some cases, the set of preferences can indicate an account lock on an account of a player of the skills-based game.

The game of chance instructions 235 can further cause the processor 205 to receive a random number from the identified host system 130A of the plurality of host systems 130A-130C of the distributed random number generator infrastructure and determine a result of the session of the game of chance based on the received random number. In some cases, receiving the random number from the identified host system 130A of the plurality of host systems 130A-130C of the distributed random number generator infrastructure and determining the result of the session of the game of chance based on the received random number can be performed in real time while conducting the session of the game of chance within the skills-based game. The game of chance instructions 235 can further cause the processor 205 to provide an indication of the determined result of the session of the game of chance, e.g., through the display device or other input/output device 225.

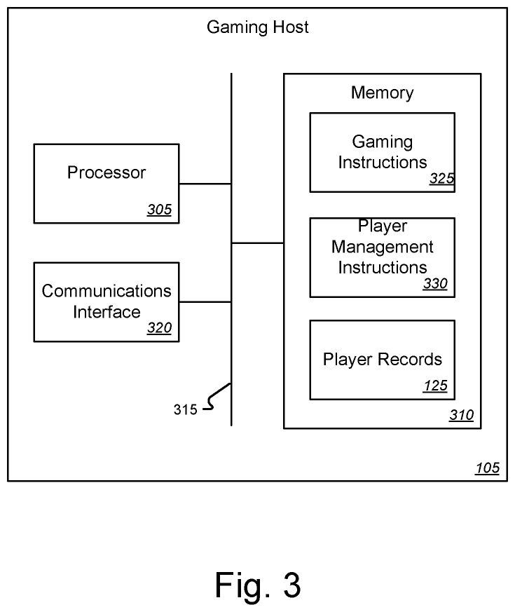

FIG. 3 is a block diagram illustrating additional details of components of an exemplary gaming host according to one embodiment of the present disclosure. As illustrated in this example, the gaming host 105 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320 via the communications bus 315. The communication interfaces 320 can comprise, for example, Ethernet, Bluetooth, WiFi, or other type of wired or wireless communications interfaces.

The memory 310 can store therein a set of gaming instructions 225 which, when executed by the processor 205, cause the processor 205 to monitor and manage skills-based game execution by the gaming system 115 as known in the art. The memory 310 can also have stored therein a set of player management instructions 330 which, when executed by the processor 305, cause the processor 305 to receive, through the communications interface 320 a set of player credentials from the gaming system 115, perform age verification based on the received 65 credentials and a set of player records 125, and provide to the gaming system 115, through the communications interface 320 an indication of the results of performing the age verification. Additionally, or alternatively, the player management instructions 330 can cause the processor 305 to receive, through the communications interface 320, one or more requests from the gaming system 115. The requests can comprise requests for player preferences, e.g., stored in the player records 125. The player management instructions 330 can cause the processor 305 to retrieve the requested player preferences provide the player preferences to the gaming system 115 through the communication interface. The preferences can define, for example, a type of game of chance the player prefers, e.g., slots, video poker, etc.

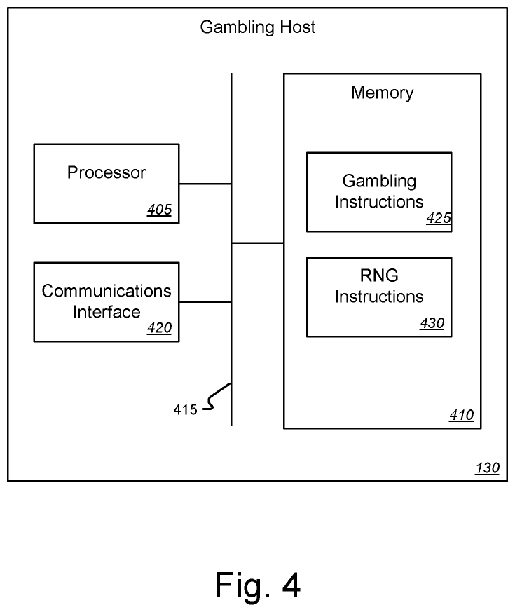

FIG. 4 is a block diagram illustrating additional details of components of an exemplary gambling host according to one embodiment of the present disclosure. As illustrated in this example, the gambling host 130 can comprise a processor 405 such as any of the various types of processors described above. A memory 410 can be coupled with and readable by the processor 405 via a communications bus 415. The memory 410 can comprise any one or more of the different types of volatile and/or non-volatile memories described above. The processor 405 can also be coupled with one or more communication interfaces 420 via the communications bus 415. The communication interfaces 420 can comprise, for example, Ethernet, Bluetooth, WiFi, or other type of wired or wireless communications interfaces.

The memory 410 can store therein a set of gambling instructions 430 which, when executed by the processor 405, causes the processor 405 to receive from the gaming system 115, through the communications interface 420 a request for information about the game of chance, such as odds, paytables, etc., retrieve the requested information and provide the requested information to the gaming system 115 through the communications interface 420. The memory 410 can also store therein a set of random number generator instructions 425 which, when executed by the processor 405, causes the processor 405 to receive a request for one or more random numbers from the gaming system 115 through the communications interface 420, generate the one or more random numbers, and provide the generated random numbers to the gaming system 115 through the communications interface.

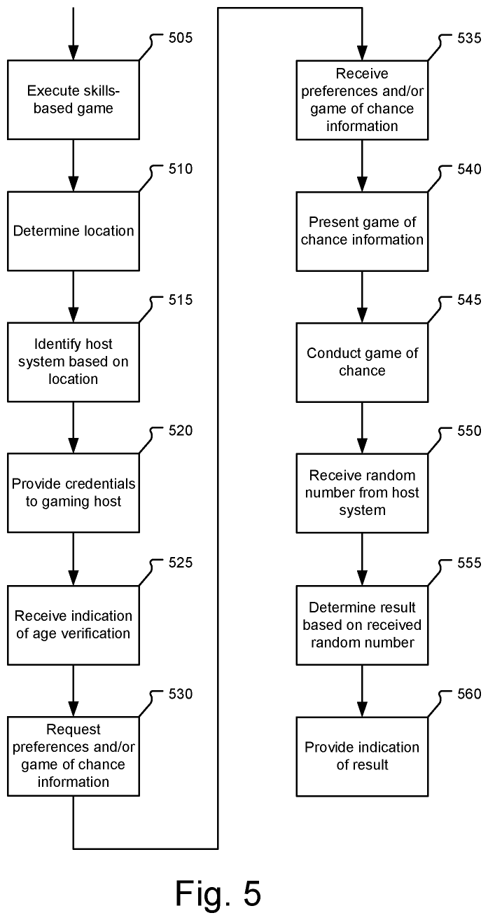

FIG. 5 is a flowchart illustrating an exemplary process for operating an electronic game according to one embodiment of the present disclosure. More specifically, this example illustrates processes as may be performed by a gaming system 115 as described above. As illustrated in this example, operating an electronic game can comprise executing 505, on the gaming system 115, a skills-based electronic game which can include a game of chance element. A geographic location at which the gaming system 115 is currently located can be determined 510 and a host system 130A of a plurality of host systems 130A-130C of a distributed random number generator infrastructure can be identified 515 based on the determined geographic location. The identified host system of the plurality of host systems of the distributed random number generator infrastructure can comprise, for example, a host system of a gaming venue within the same geographic area as determined 510 location of the player. In some cases, the gaming system 115 can provide 520, to a gaming host 105, a set of credentials for a player 120 of the skills-based game along with the determined geographic location and receive 525, from the gaming host 105, an indication of age verification for the player of the skills-based game.

Player preferences and/or game of chance information can be requested 530 from the gaming host 105 and/or gambling host 130. For example, the game of chance can comprise a wide-area progressive. In some cases, odds for winning the game of chance, a paytable for the game of chance, a set of player preferences for a player of the skills-based game, and or other information can be received 535 and presented 540 to a player of the skills-based game through a display device of the gaming system 115. For example, the paytable for the game of chance can be non-linear and can be based on an amount of a wager made on the game of chance by the player of the skills-based game.

A session of the game of chance can be conducted 545 within the skills-based game. Conducting 545 the session of the game of chance within the skills-based game can comprise conducting a wagering session of the game of chance in response to the received indication of age verification for the player of the skills-based game indicates the player is verified for wagering based on the determined geographic location. For example, the result of the wagering session of the game of chance can comprise a voucher to a gaming venue selected from a plurality of gaming venues based on the determined geographic location. Additionally, or alternatively, conducting 545 the session of the game of chance within the skills-based game can comprise conducting a non-wagering session of the game of chance in response to the received indication of age verification for the player of the skills-based game indicates the player is not verified for wagering based on the determined geographic location. The result of the non-wagering session of the game of chance can, for example, affect the skills-based game. Additionally, or alternatively, conducting 545 the session of the game of chance within the skills-based game can be based on the received preferences. For example, the set of preferences can define responsible gaming limits for conducting the session of the game of chance. The responsible gaming limits can be pre-defined by a player of the skills-based game or by the gaming host, for example. In some cases, the set of preferences can indicate an account lock on an account of a player of the skills-based game.

A random number can be received 550 from the identified 515 host system 130A of the plurality of host systems 130A-130C of the distributed random number generator infrastructure and a result of the session of the game of chance can be determined 555 based on the received random number. In some cases, receiving 550 the random number from the identified host system 130A of the plurality of host systems 130A-130C of the distributed random number generator infrastructure and determining the result of the session of the game of chance based on the received random number can be performed in real time while conducting the session of the game of chance within the skills-based game. An indication of the determined result of the session of the game of chance can then be provided 560.

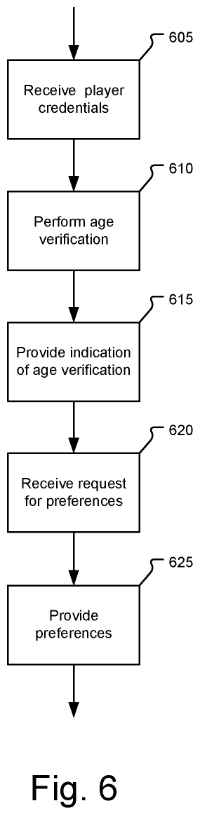

FIG. 6 is a flowchart illustrating an exemplary process for operating an electronic game according to another embodiment of the present disclosure. More specifically, this example illustrates processes as may be performed by a gaming host 105 as described above. As illustrated in this example, the process can begin with receiving 505 a set of player credentials from the gaming system 115, performing 610 age verification based on the received 605 credentials and a set of player records 125, and providing 615 to the gaming system 115 an indication of the results of performing 610 the age verification. Additionally, or alternatively, one or more requests can be received 620 from the gaming system 115. The requests can comprise requests for player preferences, e.g., stored in the player records. The requested player preferences can be retrieved and provided 625 to the gaming system 115.

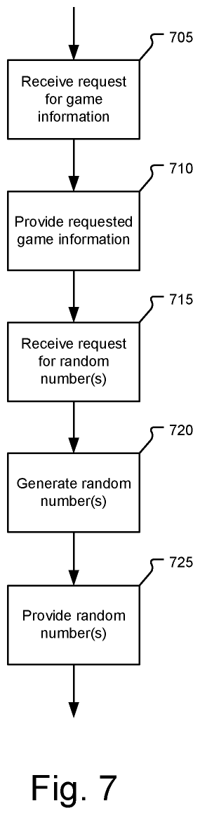

FIG. 7 is a flowchart illustrating an exemplary process for operating an electronic game according to yet another embodiment of the present disclosure. More specifically, this example illustrates processes as may be performed by a gambling host 130 as described above. As illustrated in this example, the process can begin with receiving 705 from the gaming system 115 a request for information about the game of chance. The requested information, such as odds, paytables, etc., can be retrieved and provided 710 to the gaming system. Additionally, or alternatively, a request for one or more random numbers can be received 715 from the gaming system 115. In response, the one or more random numbers can be generated 720 and provided 725 to the gaming system 115.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PUP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for operating an electronic game, the method comprising:
executing, by a gaming system, a skills-based electronic game, wherein the skills-based electronic game includes a game of chance element;
determining, by the gaming system, a geographic location at which the gaming system is currently located;
identifying, by the gaming system, a host system of a plurality of host systems of a distributed random number generator infrastructure based on the determined geographic location;
conducting, by the gaming system, a session of the game of chance within the skills-based game;
receiving, by the gaming system, a random number from the identified host system of the plurality of host systems of the distributed random number generator infrastructure;
determining, by the gaming system, a result of the session of the game of chance based on the received random number; and
providing, by the gaming system, within the skills-based game, an indication of the determined result of the session of the game of chance.

2. The method of claim 1, wherein receiving the random number from the identified host system of the plurality of host systems of the distributed random number generator infrastructure and determining the result of the session of the game of chance based on the received random number are performed in real time while conducting the session of the game of chance within the skills-based game.

3. The method of claim 1, further comprising:
providing, by the gaming system, to a gaming host, a set of credentials for a player of the skills-based game and the determined geographic location; and
receiving, by the gaming system, from the gaming host, an indication of age verification for the player of the skills-based game.

4. The method of claim 3, wherein conducting the session of the game of chance within the skills-based game comprises conducting a wagering session of the game of chance in response to the received indication of age verification for the player of the skills-based game indicates the player is verified for wagering based on the determined geographic location.

5. The method of claim 4, wherein the result of the wagering session of the game of chance comprises a voucher to a gaming venue selected from a plurality of gaming venues based on the determined geographic location.

6. The method of claim 3, wherein conducting the session of the game of chance within the skills-based game comprises conducting a non-wagering session of the game of chance in response to the received indication of age verification for the player of the skills-based game indicates the player is not verified for wagering based on the determined geographic location.

7. The method of claim 6, wherein the result of the non-wagering session of the game of chance affects the skills-based game.

8. A gaming system comprising:
a processor; and
a memory coupled with and readable by the processor and having stored therein a set of instructions which, when executed by the processor, causes the processor to:
execute a skills-based electronic game, wherein the skills-based electronic game includes a game of chance element;
determine a geographic location at which the gaming system is currently located;
identify a host system of a plurality of host systems of a distributed random number generator infrastructure based on the determined geographic location;
conduct a session of the game of chance within the skills-based game;
receive a random number from the identified host system of the plurality of host systems of the distributed random number generator infrastructure;
determine a result of the session of the game of chance based on the received random number; and
provide, within the skills-based game, an indication of the determined result of the session of the game of chance.

9. The system of claim 8, wherein the identified host system of the plurality of host systems of the distributed random number generator infrastructure comprises a host system of a gaming venue.

10. The system of claim 9, wherein the game of chance comprises a wide-area progressive.

11. The system of claim 9, wherein the instructions further cause the processor to:
receive, from the host system of the gaming venue, odds for winning the game of chance; and
present, to a player of the skills-based game, through a display device of the gaming system, the received odds for winning the game of chance.

12. The system of claim 9, wherein the instructions further cause the processor to:
receive, from the host system of the gaming venue, a paytable for the game of chance; and
present, to a player of the skills-based game, through a display device of the gaming system, the received paytable for the game of chance.

13. The system of claim 12, wherein the paytable for the game of chance is non-linear and is based on an amount of a wager made on the game of chance by the player of the skills-based game.

14. The system of claim 8, wherein the instructions further cause the processor to receive, from a gaming host, a set of player preferences for a player of the skills-based game, and wherein conducting the session of the game of chance within the skills-based game is based on the received player preferences.

15. A non-transitory, computer-readable medium comprising a set of instructions stored therein which, when executed by a processor, causes the processor to:
execute a skills-based electronic game, wherein the skills-based electronic game includes a game of chance element;
determine a geographic location at which the gaming system is currently located;
identify a host system of a plurality of host systems of a distributed random number generator infrastructure based on the determined geographic location;
conduct a session of the game of chance within the skills-based game;
receive a random number from the identified host system of the plurality of host systems of the distributed random number generator infrastructure;
determine a result of the session of the game of chance based on the received random number; and
provide, within the skills-based game, an indication of the determined result of the session of the game of chance.

16. The non-transitory, computer-readable medium of claim 15, wherein the instructions further cause the processor to receive, from a gaming host, a set of preferences for the game of chance, and wherein conducting the session of the game of chance within the skills-based game is based on the received preferences.

17. The non-transitory, computer-readable medium of claim 16, wherein the set of preferences define responsible gaming limits for conducting the session of the game of chance.

18. The non-transitory, computer-readable medium of claim 17, wherein the responsible gaming limits are pre-defined by a player of the skills-based game.

19. The non-transitory, computer-readable medium of claim 17, wherein the responsible gaming limits are pre-defined by the gaming host.

20. The non-transitory, computer-readable medium of claim 16, wherein the set of preferences indicate an account lock on an account of a player of the skills-based game.
